(19) United States
(12) Patent Application Publication
(10) Pub. No.: US 2002/0067740 A1
(43) Pub. Date: Jun. 6, 2002

(54) Multitasking gateway

(76) Inventors: Agnieszka R. Vestal, Boston, MA (US); Joseph Madden, Marlborough, MA (US); Gary Girzon, Sudbury, MA (US)

Correspondence Address: Shane H. Hunter, Mintz, Levin, Cohn, Ferris,, Glovsky and Popeo, P.C., One Financial Center, Boston, MA, 02111, US

(21) Appl. No.: 09/731,080

(22) Filed: Dec. 6, 2000

(51) Int. Cl. H04L 12/66; H04J 3/16

(52) U.S. Cl. 370/465; 370/352

(57) ABSTRACT

A telecommunications encoder for converting synchronous data to asynchronous data includes a signal processor configured to process signals to perform tasks on portions of collected synchronous data and to output asynchronous, packetized data. Control logic, associated with the signal processor, is configured to initiate performance of tasks by the signal processor at respective start times of the tasks and configured to control collection of synchronous data based on run times of the tasks such that collection of synchronous data for a given task is completed approximately at the start time of the given task.

### FIELD OF THE INVENTION

The invention relates to data processing and more particularly to coordinating data flow in a multi-channel, multitasking gateway.

### BACKGROUND OF THE INVENTION

Data communications and in particular telecommunications are becoming more important every day. With more people relying on telecommunications for more reasons, e.g., telephone conversations including hard-wired phones and cell phones, facsimiles, and email, there is an increasing priority for rapid transmission of data over telecommunications lines and networks. What was considered a short, or at least acceptable, delay in communications before is now considered painfully slow.

Reducing delays in the transmission of telecommunications data is especially important. For example, for persons talking to each other on a phone, delays of even several hundred milliseconds will become noticeable and bothersome. Delays of over several hundred milliseconds will cause a conversation to have noticeable pauses, making the conversation flow unnaturally. Delays can be introduced throughout a telecommunications system at various places, especially if the data are transferred over the global packet-switched data communications network known as the Internet. Synchronous data to be transferred over the Internet are converted into digital packetized data, transferred through the Internet through various routers, and converted back to synchronous data. All of these processes have inherent delays.

### SUMMARY OF THE INVENTION

In general, in one aspect, the invention provides a telecommunications encoder for converting synchronous data to asynchronous data. The encoder includes a signal processor configured to process signals to perform tasks on portions of collected synchronous data and to output asynchronous, packetized data. Control logic, associated with the signal processor, is configured to initiate performance of tasks by the signal processor at respective start times of the tasks and configured to control collection of synchronous data based on run times of the tasks such that collection of synchronous data for a given task is completed approximately at the start time of the given task.

Implementations of the invention may include one or more of the following features. The control logic is configured to control the signal processor to collect data for a second task, to be performed next after a first task, during operation of the first task.

The encoder may further include a co-processor coupled to the signal processor and configured to prioritize the tasks and to determine start times of the tasks depending on priorities of the tasks. The co-processor is configured to assign latency-critical functions to different tasks. The co-processor is configured to assign latency-critical functions of equal processing periods to tasks of equal priority.

Implementations of the invention may also include one or more of the following features. The signal processor comprises a DSP and the control logic comprises a DSPOS. The control logic comprises software. The control logic is configured to maintain a plurality of counters each associated with a signal processor task. The control logic is configured to decrement the counters for each task and to request that a task be run when its corresponding counter reaches a given value.

In general, in another aspect, the invention provides a telecommunications decoder for converting asynchronous data to synchronous data. The decoder includes a co-processor configured to provide asynchronous data packets upon request, a signal processor coupled to the co-processor and configured to perform tasks on asynchronous, packetized data received from the co-processor and to output synchronous data, and control logic configured to cause the signal processor to send a data request to the coprocessor in response to a start time of a task for processing data from the co-processor, being at or within a data request offset from a current time.

Implementations of the invention may include one or more of the following features. The data request offset is greater than an amount of time from when the data request is sent to the co-processor from the signal processor to when the data are received by the signal processor from the co-processor in response to receiving the data request.

The logic is further configured to maintain a plurality of task counters. The logic has an associated frequency and is configured to decrement the task counters each cycle of the logic. The logic is configured to cause the signal processor to send the data request when a task counter equals the data request offset. The data request offset is less than approximately 1 ms longer than an amount of time from when the data request is sent to the co-processor from the signal processor to when the data are received by the signal processor from the co-processor in response to receiving the data request. The co-processor is configured to control data request offsets for tasks.

In general, in another aspect, the invention provides a digital signal processor for use in a telecommunications system. The processor includes a plurality of stored telecommunication data queues, data processing circuitry configured to perform a plurality of telecommunication functions, the circuitry being configured to access the data queues to store output data from the first function in a first queue and to take data to process by a second function from a second data queue, and logic configured to control the data processing circuitry to transfer data from the first queue to the second queue for use by the second function, wherein the data queues, the data processing circuitry, and the logic are disposed on a common processing chip.

Implementations of the invention may include one or more of the following features. The logic is configured to transfer data from the first queue to multiple data queues. The plurality of data queues include output queues and input queues and the logic includes the output queues and one or more of the input queues. The logic includes a digital signal processor operating system (DSPOS) configured to control the processing circuitry to periodically transfer approximately i seconds of data from a first output queue to a first input queue in accordance with a relationship between the first input queue and the first output queue included in the logic. The relationships are stored in a 2-dimensional table indicative of data output queues and associated data input queues. The DSPOS periodically traverses the table approximately every i seconds, and wherein i equals 0.001. A digital signal processor operation system periodically transfers a portion of data from the first queue to the second queue.

Various aspects of the invention may provide one or more of the following advantages. Data latency for communications using gateways may be reduced compared to prior techniques. Speech quality for voice communications can be improved compared to prior techniques. Latency may be reduced with respect to encoding synchronous data compared to traditional encoding techniques. Digital signal processor (DSP) functions can be tightly coupled to synchronous input data. Delivery of asynchronous data can be tightly coupled to DSP processing of the data, with delay between arrival and processing of asynchronous data reduced compared to prior techniques. Asynchronous data may be allowed to have more latency between gateways than with prior techniques. Fewer asynchronous data packets may be skipped during decoding than with prior techniques. A DSP can perform decoding with small amounts of buffering of incoming data. Data can be output from a first DSP function and used by a second DSP function that has a different processing frame size (i.e., the amount of data used by the function) or period than the first function. Data can be output from one DSP function to multiple other DSP functions, and the output and input functions can be out of synchronization relative to each other. Data can be transferred between DSP functions without transferring the data off a chip containing the DSP.

These and other advantages of the invention, along with the invention itself, will be more fully understood after a review of the following drawings, detailed description, and claims.

### BRIEF DESCRIPTION OF THE FIGURES

FIG. 1 is a block diagram of a telecommunications system including a gateway according to the invention.

FIG. 2 is a timing diagram of data collection and encode processing by a digital signal processor of the gateway shown in FIG. 1.

FIG. 3 is a timing diagram of data request and decode processing by the digital signal processor shown in FIG. 1.

FIG. 4 is a schematic diagram of tasks performed by the digital signal processor shown in FIG. 1, of input and output data queues of the tasks, and of an internal queue table relating output queues and input queues.

### DETAILED DESCRIPTION OF PREFERRED EMBODIMENTS

Embodiments of the invention provide techniques for reducing processing delay in telecommunications. In particular, delays can be reduced in encoding and decoding data from synchronous to asynchronous and vice versa using a host, a co-processor, and a digital signal processor (DSP). Embodiments of the invention employ three different techniques for reducing delay. These techniques can be referred to as skewing, data request, and internal data queues.

Sending gateways traditionally have used non-skewing techniques for DSP functions. DSP functions are distributed among tasks that have respective priorities. Typically, in the non-skewed case, DSP functions with identical processing times are assigned to the same task. Data are collected simultaneously for all DSP functions within the task. When data collection completes, the associated task starts, and each DSP function running in the task is executed sequentially. The time between data collection completion and the actual execution time of the DSP function differs for each DSP function, resulting in sub-optimal and non-uniform latency for similar DSP functions.

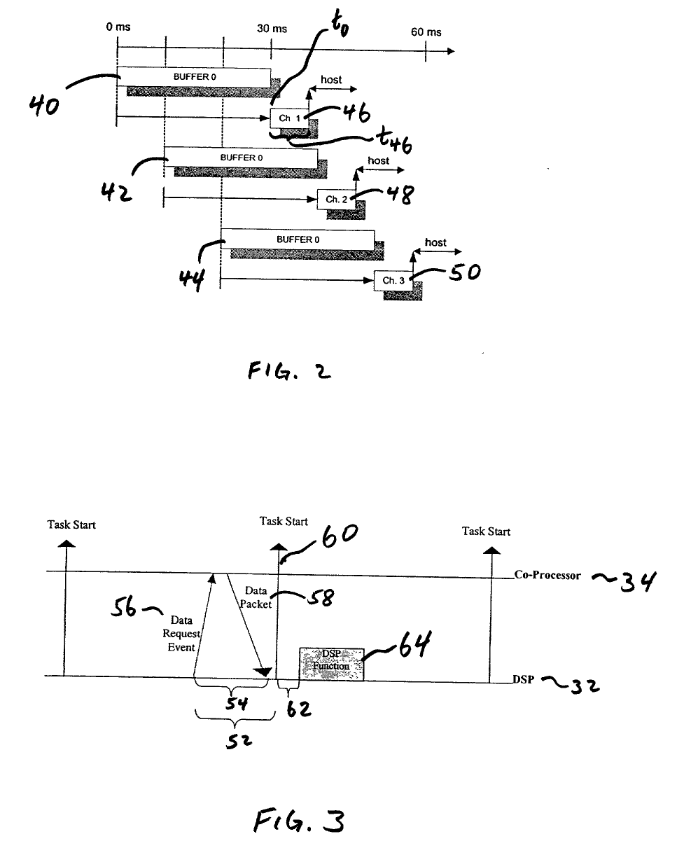

If DSP functions are deemd to be latency critical, then instead of the non-skewing technique, the skewing technique is employed. Skewing distributes latency critical functions among several tasks, each with the same priority. These tasks, and the data collection associated with these tasks, are “skewed” in time with respect to each other. Skewing allows each DSP function to start closer to the data collection associated with the task, as shown in FIG. 2, than with the non-skewed technique. DSP functions that are skewed may obtain optimal and uniform latency with respect to similar DSP functions.

The timing of DSP tasks is determined at DSP boot time based on a set of parameters that define the latency requirements of specific DSP functions. These parameters are sent from the co-processor to the DSP. Latency-critical and non-latency-critical DSP functions are separately assigned to tasks, as they are started, according to a round-robin based algorithm designed to promote even distribution of DSP functions.

Data request is employed in a receiving gateway to improve, and possibly obtain optimal or near optimal, delivery of asynchronous input data to a DSP function. Each DSP function runs on a task. A DSP Operating System (DSPOS) sends a data request to the co-processor prior to the start of each task. The co-processor delivers data to each DSP function requiring data for the task such that the data are received at or just before the task start time. The turnaround time from data request to data receipt is well known so the request can be timed to ensure that the data are present at or near the DSP task start time. By reducing the delay between data receipt and data processing, overall system latency is reduced.

Internal data queues are used to provide data output by one DSP process to the input of another DSP process, without sending the data off-chip (i.e., off a chip containing the DSP). Data often need to be serially processed by DSP functions. Typically, the output data of one DSP function are sent off-chip, and then sent back on-chip to the input of the second DSP function in the series of functions. Using the invention, the output data are sent from the output queue of one DSP function to the input queue of another DSP function. This is accomplished using a two-dimensional table indicating source and destination of data. The DSP operating system copies 1 ms (although other segments of time are acceptable) of data at a time from the output queue indicated in the table to the input queue indicated in the table for each input queue identity in the table. Using the internal data queue approach, serial DSP functions do not need to be synchronized, the second function can process the data whenever it comes to the fore of the function's input queue.

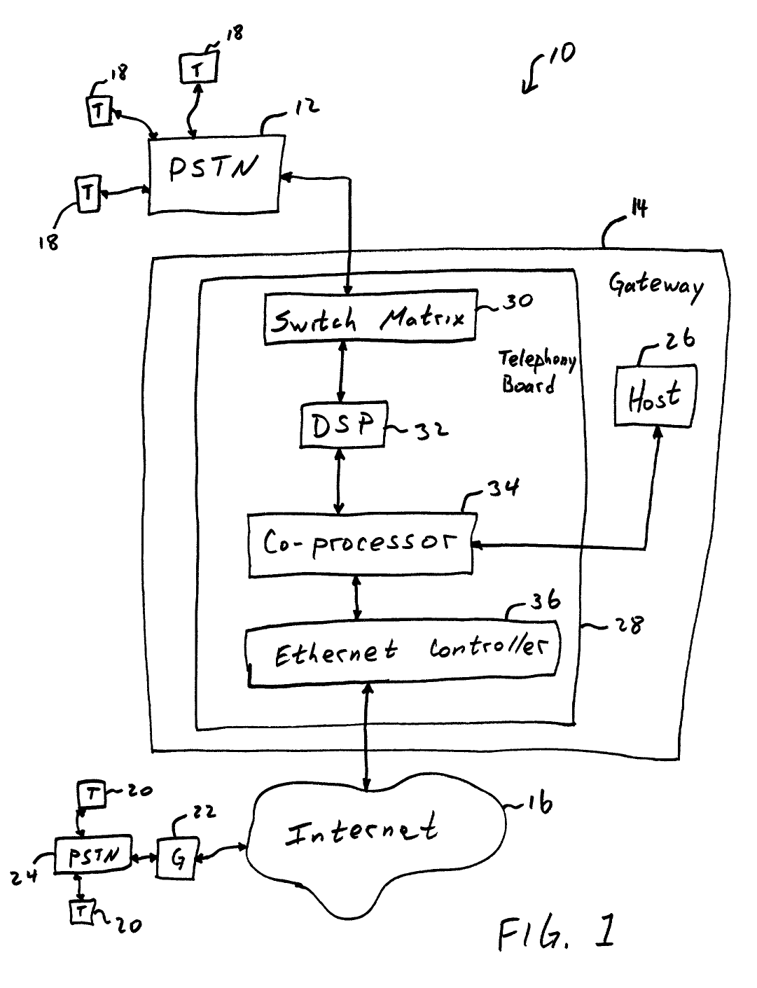

Referring to FIG. 1, a telecommunication system 10 includes Public-Switched Telephone Networks (PSTNs) 12, 24, a multi-channel, multitasking gateway 14, the global packet-based data communication network known as the Internet 16, a gateway 22, and terminals 18, 20. The system 10 is configured to convey synchronous data to and from the terminals 18 connected to the PSTN 12 and the terminals 20 connected to the Internet 16 through the gateway 22 and the PSTN 24. The PSTN 12 is configured to receive and transmit synchronous data selectively to and from the terminals 18 and to and from the gateway 14. The gateway 14 is configured, and coupled, for bidirectional communication with the PSTN 12 and the Internet 16. The gateway 14 includes a host 26 coupled for bi-directional communication with a telephony board 28. The telephony board 28 includes a switch matrix 30, one or more digital signal processors 32 (DSPs), a co-processor 34, and an Ethernet controller 36. The gateway 14 is configured to receive synchronous data from the PSTN 12, convert these data to asynchronous, packetized data and transmit the packetized data to the internet 16. The gateway 14 is further configured to receive packetized data from the Internet 16, convert these data to synchronous data, and transmit the synchronous data to the PSTN 12.

The switch matrix 30 is configured to selectively couple the DSP 32 to PSTN lines. For example, the switch matrix 30 can connect T1 lines and/or E1 lines from one or more PSTNs e.g., the PSTNs 12, 24 to the DSP 32. The switch matrix 30 is further configured to send and receive synchronous data to and from the PSTN 12 and to and from the DSP 32.

The DSP 32 is configured to perform various telecommunication functions. These functions are arranged in groups called tasks and may include functions of encoding synchronous data, decoding packetized data, detecting dual-tone multi-frequency (DTMF) signals, echo canceling, tone generating, CED tone detecting, and dual-tone multi-frequency (DTMF) tone detecting.

DSP operations are controlled by the DSPOS. The DSPOS is software that is downloaded into the DSP 32 through the co-processor 34 from the host 26 at boot time of the gateway 14. The DSP 32 and DSPOS are disposed on a common processor chip (e.g., an integrated circuit chip). DSP functions are arranged in tasks according to the DSPOS that is configured to control and coordinate data flow to and from the task and functions within the task. The DSPOS also regulates timing of data collection and supply to the DSP 32 for performing the various functions. The DSPOS also controls the timing of the start times for the functions.

The DSP 32 is also configured for bi-directional communication with the co-processor 34. The DSP 32 is configured to send data requests and data acknowledgements to the co-processor and to send and receive packets of data to and from the co-processor 34.

The co-processor 34 is connected for bi-directional communications with the host 26. The host 26 is configured to store control information for the DSP 32 and to transmit the control information to the co-processor 34 at the boot time of the gateway 14. The control information includes the DSPOS image and various DSP functions such as the telecommunication functions mentioned above. The co-processor 34 is configured to receive and process the control data and other data from the host 26 at boot time of the gateway 14. The co-processor 34 is configured to process data from the host 26 to determine and set up task start times for the DSP 32. If latency critical DSP functions exist for a given period, then multiple tasks are produced for that period. Otherwise, a single task is produced for that period. All functions for a given period are distributed among, preferably, all tasks for that period, based on a round-robin algorithm. An internal queue table is produced in the DSP 32 for coordinating data flow for functions of the DSP 32. The co-processor configures the DSPOS for issuing data requests from the DSP 32. Also, the co-processor determines the DSP timing including the task start times and also determines grouping of functions into tasks. The co-processor 34 is configured to send commands and parameters to the DSP 32, e.g., to establish the DSPOS with the function grouping and timing, data request functionality, and data flow. The co-processor 34 is further configured to send data packets to, and receive data packets from, the DSP 32. Also, the co-processor 34 is configured to send and receive packets of data to and from the Ethernet controller 36.

The Ethernet controller 36 is configured to coordinate the transfer of data packets between the Internet 16 and the co-processor 34. The Ethernet controller 36 directs the data packets from the co-processor 34 into a desired path through the Internet 16 towards one or more terminals 20.

Referring to FIG. 2, the DSPOS is configured to coordinate the timing of data collections and DSP functions for, e.g., optimally, processing synchronous data. FIG. 2 shows the timing of three data collection operations 40, 42, 44 and three corresponding task executions 46, 48, 50. Three operations and executions are shown for illustration; more or fewer operations and executions may be performed. Also, each task may include one or more DSP functions. For reference, the data collection operation 40 is shown beginning at a time designated as 0 ms. The three data collection operations 40, 42, 44 are each 30 ms long, although other lengths of data collections are possible. The three DSP task executions 46, 48, 50 are shown corresponding to three different channels, Ch. 1, Ch. 2, and Ch. 3. These executions 46, 48, 50 could, however, be for less than three channels.

The DSPOS is based on a preemptive multitasking kernel that supports up to n tasks (e.g., seven tasks). Each task may be assigned a priority, with higher priority tasks preempting lower priority tasks at a DSPOS tick (the beginning of a DSPOS cycle). The DSPOS is configured to cause the tasks 46, 48, 50 to execute sequentially.

The DSP functions may have critical or non-critical latencies. DSP functions with similar periods and non-critical latencies are assigned to a single task in accordance with the DSPOS. For example, all DTMF detectors for all ports of a gateway, having a period of 2 ms, may be assigned to task #1. Task #1 may be the only task with functions having periods of 2 ms. DSP functions that are latency critical can be distributed among a set of tasks, in accordance with the DSPOS, within a given period (with similar durations). Each of the tasks within this period are offset (e.g., delayed or skewed) with respect to one another, but all have the same priority and therefore cannot interrupt each other.

The DSPOS is configured to coordinate the timing between the data collections 40, 42, 44 and the task executions 46, 48, 50. The DSPOS is configured to coordinate these timings such that the data collections 40, 42, 44 are completed just prior to the corresponding task executions 46, 48, 50, respectively. The DSP task executions 46, 48, 50 are thus tightly coupled to collection of their synchronous input data. The task executions 46, 48, 50 are timed in accordance with the DSPOS configuration such that the task 48 begins executing shortly after the completion of the task execution 46, and the task 50 begins executing shortly after the completion of task execution 48. The offset between task executions, measured in DSPOS ticks, is part of the configuration of the DSPOS as originally configured by the co-processor 34 at gateway 14 bootup time. Preferably, the DSP functions are distributed among tasks such that there is one DSP function (e.g., a unique DSP function instance) per task. Also, preferably the offset times between task execution 46, 48, 50 start times are approximately equal to the respective processing times of the single instance of the immediately-preceding DSP function. Thus, if task execution 46 takes a time t₄₆ to execute and begins at a time t₀, then task execution 48 begins approximately at a time t₀+t₄₆.

The DSPOS is configured to coordinate the timing of the data collections 40, 42, 44 and task executions 46, 48, 50 as shown in FIG. 2 using counters that are decremented each DSPOS tick. The DSPOS maintains a table of counters, with one counter per kernel task. The counters for each of the tasks 46, 48, 50 are initially set to equal the amount of time of the initial data collection 40 for the task 46. The counters for each task are adjusted to reflect the desired skewing for each task. More tasks than those shown in FIG. 2 are possible, with counters for the corresponding tasks being initially set in this similar fashion. The DSPOS is configured to decrement the counters each DSPOS tick. The DSPOS is configured such that when a counter reaches zero, the DSPOS posts a signal to the kernel requesting that the task be run. The DSPOS is configured to reset the counter for a respective task to the task's period. The task period is the amount of time between executions of the same task.

In operation, encoding proceeds as shown in FIG. 2. Data are collected during collection 40 for the task 46. The counter for task 46 reaches zero when the data collection 40 completes. In response to the counter reaching zero, the DSPOS resets the counter for task 46 to the period of task 46 and initiates execution of the task 46. The data collection 42 proceeds at a time such that the data collection 42 will complete very close to the time that task 46 completes. The completion of data collection 42 may be just before or just after completion of the task 46. At the time that the data collection 42 completes, the counter for task 48 reaches zero. In response to this counter reaching zero, the DSPOS resets the counter for task 48 to the period for task 48, and initiates execution of the task 48. A similar process is followed with respect to data collection 44 and task execution 50, as well as other data collections and task executions, if any (not shown).

Referring to FIG. 3, the DSPOS is further configured to control the DSP 32 to coordinate timing of data delivery to the DSP for decoding data. The DSPOS is configured to control the DSP 32 to request data from the co-processor 34 in accordance with a data request offset time 52 that depends on a data request turnaround time 54. The data request turnaround time 54 is the time it takes for the DSP 32 to transmit a data request 56 to the co-processor 34, plus the time for the co-processor 34 to process the data request, plus the time for the co-processor 34 to transmit a data packet 58 to the DSP 32 in response to the processed data request. The data request offset 52 is a configurable parameter specified at boot time of the Gateway 14 (FIG. 1) and is dependent upon the known data request turnaround time. Specifically, the data request offset is equal to the data request turnaround time 54 plus an arbitrary amount of time as a safety factor to help ensure that the data packet 58 from the co-processor 34 is received by the DSP 32 before a desired task start time. The DSPOS is configured to maintain a table of task counters, corresponding to various tasks, that are used for scheduling task executions. The DSPOS is configured to decrement each element of the table every DSPOS tick. The DSPOS is further configured such that when the task counter for a given task equals the data request offset for that given task, the DSP 32 transmits a data request 56 to the co-processor 34.

In operation, asynchronous data are decoded according to the timing shown in FIG. 3. The table of task counters is initiated by the co-processor 34 in the DSPOS at boot time of the Gateway 14 (FIG. 1). Each DSPOS tick, the DSPOS decrements the counters in the task counter table. When the task counter for a given task (e.g., the task shown in FIG. 3) reaches the data request offset, the DSP 32 issues a data request 56 to the co-processor 34. The data request 56 is transmitted to the co-processor 34, that processes the request 56, and transmits a data packet 58 to the DSP 32 in response to the request 56. The DSP 32 receives the data packet 58 at a time from the beginning of the data request offset 52 equal to the data request turnaround time 54. At the next task start time 60, the task is initiated. There is a DSP function delay time 62 between the task start time 60 and when a DSP function 64 begins executing. The DSP function 64 executes, decoding asynchronous data in the data packet 58 into synchronous data that can be transmitted to the PSTN 12 (FIG. 1) through the switch Matrix 30 (FIG. 1). Using this process, the data packet 58 is received by the DSP 32 a short time before the task start time 60. The task is initiated at the first task start time 60 following the receipt time of the data packet 58 by the DSP 32.

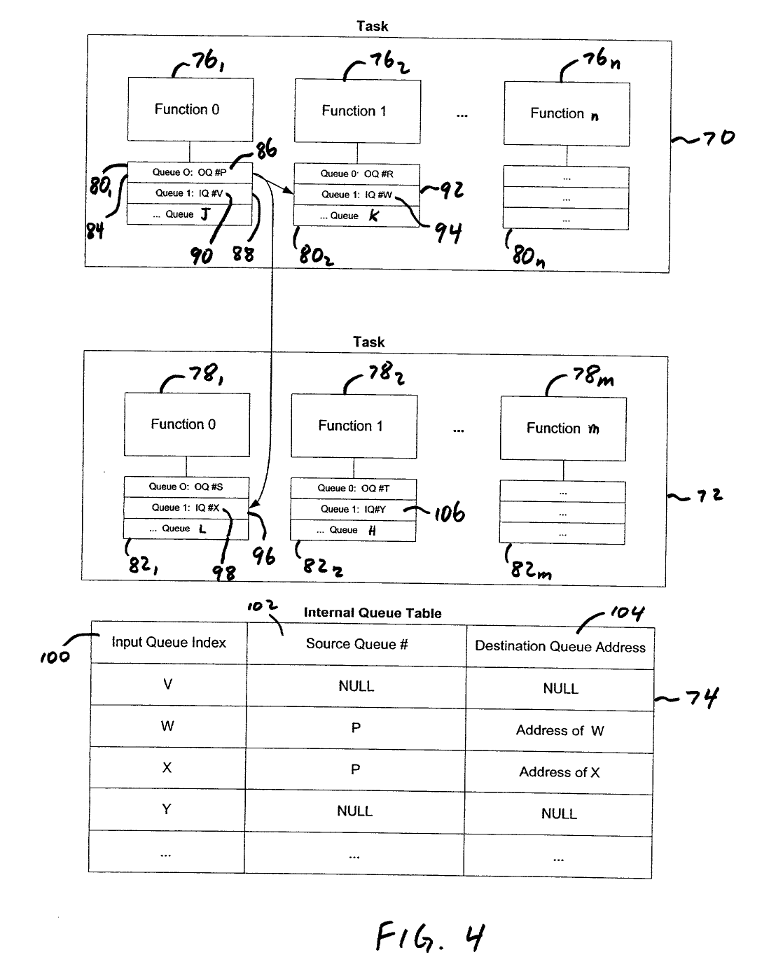

Referring to FIG. 4, the DSPOS is configured to coordinate data flow and operation of tasks 70, 72 in accordance with an internal queue table 74. Operation of the tasks, 70, 72 is coordinated by the DSPOS to control the DSP 32 (FIG. 1) to perform the various functions contained within the tasks 70, 72 and to transfer data between queues corresponding to the functions.

Tasks 70 and 72 each have corresponding functions 76₁-76ₙ and 78₁-78ₘ, respectively, that each have associated sets 80₁-80ₙ and 82₁-82ₘ of internally-connected queues of data. Each function 76, 78 may have zero, one, or more internally-connected data queues and/or non-internally-connected data queues (not shown). The functions 76, 78 are configured according to the DSPOS to manipulate data from the queues to perform various operations. The functions 76, 78 can be the same or different. As shown, the tasks 70, 72 each include multiple functions, task 70 including n functions and task 72 including m functions, that are each integers equal to or greater than three. This, however, is not necessary; the tasks 70, 72 can contain as few as zero functions 76, 78.

Data to be operated on by the functions 76, 78 are provided in the sets 80, 82 of queues of data. As shown, there are multiple queues of data in each set 80, 82 corresponding to respective functions 76, 78. A function, however, need not have more than one internal or non-internal queue of data associated with it. The indicated amounts J, K, L, and H of queues in the respective sets 80₁, 80₂, 82₁, 82₂ may be the same or different. As shown, queue 801 includes J queues with a queue 84 of set 80₁ being an output queue as indicated by the label OQ. All of the queues in the sets 80, 82 include unique global queue addresses and unique global queue IDs. For queue 84, the global unique queue ID 86 is P. The set 80₁ further includes a queue 88 that is an input queue as indicated by the label IQ, and that has a unique global ID address 90 of V. Similarly, a queue 92 of set 80₂ is an input queue with an ID 94 of W. A queue 96 of set 82₁ is an input queue with an address 98 of X.

The internal queue table 74 is stored as part of the DSPOS and contains information for coordinating data flow between the queues. The queue table 74 includes an input queue index 100, a column 102 of corresponding source queue IDs, and a column 104 of corresponding destination queue addresses. The input queue index 100 contains a list of global IDs for corresponding input queues. The column 102 of source queue numbers includes the global IDs of output queues corresponding to the input queues listed in the input queue index 100. The source queues are the output queues from which corresponding input queues will receive data. The column 104 of destination queue addresses includes the addresses of the input queues that are to receive data from corresponding output queues.

In operation, the DSPOS controls the DSP 32 (FIG. 1) to perform the functions 76, 78 and to transfer data using the data queues. Each DSPOS cycle or tick every i ms (e.g., 1 ms) the DSP 32 traverses the table 74 and moves one time slice of data, equal to the length of time between DSPOS ticks, to input data queues and from output data queues if data are available. Data to be moved are moved in accordance with the internal queue table 74. The data are moved regardless of the amount of time that a corresponding function 76, 78 uses or operates on to perform its function.

The DSP 32 uses the information in table 74 to determine from where to pull data and to where to move data. Thus, for the exemplary information shown in table 74, each DSPOS tick the DSP 32 pulls one DSPOS tick worth of information from source queue P and transfers these data to input queues W and X in accordance with the addresses of W and X stored in association with the source queue P in column 104 of the table 74. The DSP 32 zero fills the input queue 90 each DSPOS tick because the internal queue table 74 indicates that there is no source queue from which to transfer data into the queue 90. The same is true for an input queue 106 having global address Y. Output queues that do not appear in column 102 of table 74 are ignored unless an internal connection is established.

Other embodiments are within the scope and spirit of the appended claims.

What is claimed is:

1. A telecommunications encoder for converting synchronous data to asynchronous data, the encoder comprising:
a signal processor configured to process signals to perform tasks on portions of collected synchronous data and to output asynchronous, packetized data; and
control logic, associated with the signal processor, configured to initiate performance of tasks by the signal processor at respective start times of the tasks and configured to control collection of synchronous data based on run times of the tasks such that collection of synchronous data for a given task is completed approximately at the start time of the given task.

2. The encoder of claim 1 wherein the control logic is configured to control the signal processor to collect data for a second task, to be performed next after a first task, during operation of the first task.

3. The encoder of claim 1 further comprising a co-processor coupled to the signal processor and configured to prioritize the tasks and to determine start times of the tasks depending on priorities of the tasks.

4. The encoder of claim 3 wherein the co-processor is configured to assign latency-critical functions to different tasks.

5. The encoder of claim 4 wherein the co-processor is configured to assign latency-critical functions of equal processing periods to tasks of equal priority.

6. The encoder of claim 1 wherein the signal processor comprises a DSP and the control logic comprises a DSPOS.

7. The encoder of claim 1 wherein control logic comprises software.

8. The encoder of claim 1 wherein the control logic is configured to maintain a plurality of counters each associated with a signal processor task.

9. The encoder of claim 8 wherein the control logic is configured to decrement the counters for each task and to request that a task be run when its corresponding counter reaches a given value.

10. A telecommunications decoder for converting asynchronous data to synchronous data, the decoder comprising:
a co-processor configured to provide asynchronous data packets upon request;
a signal processor coupled to the co-processor and configured to perform tasks on asynchronous, packetized data received from the co-processor and to output synchronous data; and
control logic configured to cause the signal processor to send a data request to the co-processor in response to a start time of a task for processing data from the coprocessor, being at or within a data request offset from a current time.

11. The decoder of claim 10 wherein the data request offset is greater than an amount of time from when the data request is sent to the co-processor from the signal processor to when the data are received by the signal processor from the co-processor in response to receiving the data request.

12. The decoder of claim 10 wherein the logic is further configured to maintain a plurality of task counters.

13. The decoder of claim 12 wherein the logic has an associated frequency and is configured to decrement the task counters each cycle of the logic.

14. The decoder of claim 13 wherein the logic is configured to cause the signal processor to send the data request when a task counter equals the data request offset.

15. The decoder of claim 14 wherein the data request offset is less than approximately 1 ms longer than an amount of time from when the data request is sent to the co-processor from the signal processor to when the data are received by the signal processor from the co-processor in response to receiving the data request.

16. The decoder of claim 14 wherein the co-processor is configured to control data request offsets for tasks.

17. A digital signal processor for use in a telecommunications system, the processor comprising:
a plurality of stored telecommunication data queues;
data processing circuitry configured to perform a plurality of telecommunication functions, the circuitry being configured to access the data queues to store output data from the first function in a first queue and to take data to process by a second function from a second data queue; and
logic configured to control the data processing circuitry to transfer data from the first queue to the second queue for use by the second function;
wherein the data queues, the data processing circuitry, and the logic are disposed on a common processing chip.

18. The digital signal processor of claim 17 wherein the logic is configured to transfer data from the first queue to multiple data queues.

19. The digital signal processor of claim 17 wherein the plurality of data queues include output queues and input queues and the logic includes the output queues and one or more of the input queues.

20. The digital signal processor of claim 19 wherein the logic includes a digital signal processor operating system (DSPOS) configured to control the processing circuitry to periodically transfer approximately i seconds of data from a first output queue to a first input queue in accordance with a relationship between the first input queue and the first output queue included in the logic.

21. The digital signal processor of claim 20 wherein the relationships are stored in a 2-dimensional table indicative of data output queues and associated data input queues.

22. The digital signal processor of claim 21 wherein the DSPOS periodically traverses the table approximately every i seconds, and wherein i equals 0.001.

23. The digital signal processor of claim 17 wherein a digital signal processor operation system periodically transfers a portion of data from the first queue to the second queue.
